(19) United States
(12) Patent Application Publication
(10) Pub. No.: US 2021/0316774 A1
(43) Pub. Date: Oct. 14, 2021

(54) METHODS RELATING TO COMBAT SPORT EQUIPMENT

(71) Applicant: Michael Carney, Stoke on Trent (GB)

(72) Inventor: Michael Carney, Stoke on Trent (GB)

(21) Appl. No.: 17/034,823

(22) Filed: Sep. 28, 2020

Related U.S. Application Data
(63) Continuation-in-part of application No. 16/847,260, filed on Apr. 13, 2020.

(51) Int. Cl. B62B 5/06; B62B 3/14; B65D 25/28

(52) U.S. Cl. CPC B62B 5/06; B65D 25/2867; B62B 3/1436

(57) ABSTRACT

The invention provides a method of holding combat sport equipment, wherein the method comprises the steps of: providing a container, and placing combat sport equipment in the container. The container comprises: (a) a hollow body defined by four sidewalls that extend from a closed base to an open mouth; and (b) a handle provided on one of the sidewalls of the hollow body. The handle comprises a first elongate member and a second elongate member, wherein the first elongate member has an elongate axis that lies parallel to the plane of the closed base; and the second elongate member has an elongate axis that lies perpendicular to the plane of the closed base.

### CROSS-REFERENCE TO RELATED APPLICATIONS

This application is a continuation-in-part of U.S. Ser. No. 16/847,260, filed Apr. 13, 2020.

### FIELD OF THE INVENTION

The present invention relates to a container for combat sport equipment, such as boxing equipment, and to methods of using the container for holding combat sport equipment.

### BACKGROUND TO THE INVENTION

Containers that have specific features to suit their intended use for a particular activity are known. For example, containers have been specifically designed to have features to suit their use as drinks coolers, toolboxes, camping equipment organisers, or portable kitchen cabinets.

For example, US 2013/007979 describes a toolbox that includes a vacuum cleaner. This toolbox includes a handle that is moveable relative to the body of the toolbox and that a user would hold in a horizontal orientation to drag the toolbox along behind them. The inner surface of the lid of the toolbox includes attachment points for parts of the vacuum cleaner.

U.S. Pat. No. 6,173,839 describes an organiser designed to be used for camping. The handles of this organiser are, in use, held in a horizontal orientation and are not rigid. The organiser has non-rigid fabric sidewalls so that it can be collapsed for storage.

U.S. Pat. No. 6,315,149 describes a portable drinks cooler that has a double lid configuration. A handle folds out from the side of the cooler and can be used to pull it along on its wheels. The drinks cooler also includes notches built into the sides of the cooler. Both the handle and the notches of the drinks cooler are, in use, held in a horizontal orientation.

US2014/077467 and WO 2015/066559 also describe portable drinks coolers. The drinks coolers of these documents each have a telescopic handle that moves relative to the body of the container. A user can drag the cooler along behind them by holding the telescopic handle in a horizontal orientation. The drinks cooler of WO 2015/066559 includes an integrated blender and a holder for plates, which are provided on the inner surfaces of its lid.

U.S. Pat. No. 8,997,994 describes a portable kitchen storage cabinet which can be fitted on the tailgate of a pickup truck. The portable kitchen cabinet has a lid that opens to reveal a work surface, which is provided at ground level i.e. at the same level as the base of the cabinet. Handles on the sides of the cabinet pivot relative to its body, and allow the user to hold the handle horizontally.

In combat sports, such as boxing, fighters commonly require large amounts of equipment when they are sparring or competing in shows. This may be carried by the fighter themselves or by a “corner man” or other team member who supports the fighter. The equipment may include towels, sponges, water bottles, energy supplements, ice packs, enswells (anti-swell/bruising irons, also known as no swells) and first aid equipment. First aid equipment may, in particular, include cotton wool buds (swabs), bandages, dressings and/or plasters, scissors, latex gloves, chemicals such as petroleum jelly, astringents, ephinephrine and/or clotting agents, and tape.

Fighters conventionally carry their equipment in containers that are in the form of buckets, trays, and/or bags. The buckets and bags used are usually not specifically designed for use in combat sport, but rather are known and standard products.

In particular, it is common for rudimentary buckets, termed “builder's buckets”, to be used. Such buckets have an elongate body extending from a closed end to an open mouth. Normally the body has a circular cross section and it may taper so as to be wider at the mouth than the closed end. A handle is pivotally attached to the body and can be moved to extend upwardly over the centre of the mouth of the bucket, enabling the user to lift and carry the bucket. The handle is grasped in a horizontal orientation.

Fighters will often use their bucket as a spittoon, as well as a container to carry equipment.

Such a builder's bucket may commonly be used in combination with a holdall type bag with a shoulder strap to also carry equipment and/or clothing.

A builder's bucket may also be used in combination with a “tote” tray (also known as a “carry all” or “caddy” tray), which is a tray having one or more compartments and a fixed central handle enabling the user to lift and carry the tray. The tray is normally rectangular in cross section and will commonly be used to carry first aid equipment and/or ice.

A builder's bucket is typically provided by a promotor for a show and may be shared between a number of fighters in each show.

### SUMMARY OF THE INVENTION

The present inventor has recognised that the conventionally used bucket in combat sports is difficult to move between or under the ropes that mark the perimeter of the fighting area, e.g. boxing ring. This difficulty stems from the in-use position of the handle of the bucket, where it extends upwardly from the top of the bucket. The ropes therefore obstruct the handle, as well as the user's arm and hand that is holding the handle, preventing the bucket from being moved fully into the ring. The user will typically be able to carry the bucket by its handle to a position that is about half-way past the ropes before needing to let go of the handle and instead push the bucket along the floor of the ring to a position where it is fully past the ropes. This pushing action against the side of a bucket is less controlled and presents a particular risk with regard to the contents of the bucket spilling or splashing out.

The present inventor has also recognised that the current arrangements in combat sports are unhygienic and present health and safety issues. The bucket ends up containing an unpleasant and unhygienic mixture of phlegm, blood, water, adrenaline-soaked cotton wool buds and petroleum jelly that presents a health and safety problem if the bucket is knocked over. Further, because a bucket will typically be used by numerous competitors throughout a show, the bucket will contain phlegm and/or blood from different people, which exacerbates the hygiene and health and safety problems.

Furthermore, the inventor has recognised that in using a conventional bucket to both carry equipment and act as a spittoon during combat sports, the equipment is then left on the floor of the ring during the fight so that the bucket is empty for use as a spittoon. This is potentially unhygienic if the floor isn't clean. Time and effort is also required to empty the bucket of equipment before the fight begins and to then load equipment back into the bucket after the fight ends. In addition, this results in the period of time that the corner man has to attend to the fighter during the fight, e.g. to deal with a cut or a swollen eye, being reduced due to time spent searching for items on the floor of the ring.

Therefore the inventor has recognised a number of problems with the current arrangements in terms of containers used in combat sports.

According to a first aspect, the present invention provides a method of holding combat sport equipment, wherein the method comprises the steps of:
providing a container, the container comprising:
   a hollow body defined by four sidewalls that extend from a closed base to an open mouth; and
   a handle provided on one of the sidewalls of the hollow body, the handle comprising a first elongate member and a second elongate member, wherein:
      the first elongate member has an elongate axis that lies parallel to the plane of the closed base; and
      the second elongate member has an elongate axis that lies perpendicular to the plane of the closed base;
         and
placing combat sport equipment in the container.

The method may be a method of moving combat sport equipment and therefore may optionally comprise the further step of:
moving the container having combat sport equipment therein, so as to move the combat sport equipment from a first location to a second location.

The moving step may be carried out by a user who is a human and who may be an adult or may be a child over 11, such as a teenager. The handle of the container can be gripped by the hand of the user in this moving step.

One or more steps of the method of the first aspect may be carried out before, during or after a combat sport event or contest, e.g. a boxing match or martial arts fight. The present invention will find particular use in combat sports where fights are conducted in a ring, such as boxing, kickboxing, MMA and wrestling. The invention may be used during sparring or when competing in shows.

It may be that the container is moved from a first location outside a fighting area to a second location inside a fighting area or it may be that the container is moved from a first location inside a fighting area to a second location outside a fighting area. The container may be moved between or under ropes that mark the perimeter of the fighting area, e.g. boxing ring.

It may be that the movement comprises using the handle of the container. It may be that the movement comprises using the handle of the container to push the container. It may be that the movement comprises using the handle of the container to both lift the container and push the container into position.

The method of the present invention is beneficial in that the container can be manoeuvred between or under the ropes of a ring in a single straightforward movement, by use of the handle that is located on one of the sidewalls. This handle can be held by the user and used to push the container into a desired position.

Further, the movement can be carried out in a controlled manner. This reduces or prevents the likelihood of any liquid in the container spilling or splashing out.

The positioning of the handle on a sidewall of the hollow body means that the user will be able to push the container of the present invention fully beyond (between or under) the ropes, into the ring, in one controlled movement. The ropes of the ring will not obstruct the handle or the user's arm when the user tries to move the container between or under the ropes of a ring. This significantly reduces the risk of spilling any contents of the container.

Furthermore, the same handle can be used to both lift the container and push the container into position. The user can hold onto the second elongate member of the handle to push the container into a desired position. The inclusion of the first elongate member assists with lifting of the container. In this regard, part of the user's hand, e.g. their index finger, can engage with the first elongate member during lifting of the container.

The handle should be in a fixed position relative to the hollow body in use, i.e. it does not move (e.g. pivot or telescope) relative to the hollow body during use. The orientation of the handle with respect to the hollow body does not change. The handle is preferably in a fixed position relative to the hollow body, i.e. it cannot pivot or telescope or otherwise move relative to the hollow body. The orientation of the handle with respect to the hollow body cannot change. The handle may be integral with the hollow body or securely attached thereto. This provides excellent control of the movement of the container.

As noted above, traditional “builder's buckets” have a handle that extends over the top of the bucket and that moves pivotally. This provides limited control when moving the bucket, because the bucket can still sway. Further, the user cannot push the bucket using the pivoting handle, but rather can only use the pivoting handle to lift the bucket.

In one optional embodiment, the container may also comprise a lid having an inner surface that comprises a flat area, an outer surface, and four edges, wherein one of the edges is pivotally connected to one of the sidewalls of the hollow body and wherein the lid can pivot between an open position, in which the lid does not cover the open mouth and in which the flat area of the inner surface lies parallel to the plane of the closed base, and a closed position, in which the lid partly or completely covers the open mouth.

In this optional embodiment where the container includes the lid, the container of the present invention is further beneficial in that in the open position of the lid the flat area of the inner surface lies parallel to the plane of the closed base. This therefore provides a work surface. In use, this work surface will be horizontal.

Accordingly, the user of this optional embodiment of the present invention can place equipment, such as first aid equipment, in a convenient and easily accessible location. The work surface can be kept clean by the user and therefore the cleanliness of the equipment can be ensured. Therefore this optional embodiment of the present invention provides a more hygienic approach.

In addition, in this optional embodiment where the container includes the lid, because the open mouth of the container is not covered when the lid is in the open position, the contents of the container are accessible when the work surface is in use. Therefore during the fight, the lid can be placed in the open position, to provide ready access to any equipment within the container and also to provide an easily accessible work surface on which equipment can be placed.

In one embodiment, the container as used in the method of the first aspect is adapted to receive one or more removable receptacles. For example, the container may include one or more support members and the removable receptacle can be placed inside the container so as to engage with, and be supported on, said support members.

In one embodiment, the method comprises using the container with a removable receptacle, wherein the container is adapted to receive the removable receptacle. The removable receptacle may be adapted to sit on the closed base of the hollow body. Preferably the removable receptacle is sized and shaped such that it can fit inside the hollow body or a compartment thereof, in that the removable receptacle is secure (prevented from moving laterally) within the hollow body or a compartment thereof during transportation. This is particularly beneficial when the removable receptacle is a spittoon. Prevention of movement of the removable receptacle within the hollow body or a compartment thereof will reduce the likelihood of any contents, e.g. potentially infectious bodily fluids, within the removable receptacle spilling or sloshing out.

The container may include one or more support members and the removable receptacle can be placed inside the container so as to engage with, and be supported on, said support members.

In one preferred embodiment, the removable receptacle is a spittoon. Being able to remove the spittoon from the container allows a plurality of spittoons to be used with the same container. Different fighters can each have an individual spittoon to be used with the same container, which allows different fighters to use the same container whilst minimising the risk of transfer of potentially infectious bodily fluids between fighters. It may be that the plurality of spittoons are able to be differentiated from one another, e.g. through the use of different colours, patterns, labels, words or symbols, so that each fighter can identify their own spittoon.

Being able to remove the spittoon from the container also allows the spittoon to be brought to the fighter's face for them to spit into. This reduces the risk of bodily fluids being spread outside of the spittoon when compared to spitting into a spittoon that is positioned at a distance from the fighter, e.g. on the floor next to the fighter.

Being able to remove the spittoon from the container also allows the spittoon to be sanitised more easily and thoroughly than would be possible if the spittoon was part of the container.

The spittoon may optionally include a handle. The handle can used to enable the spittoon to be removed from the container. The handle may optionally extend vertically from the removable receptacle. The handle may be elongate. The handle may have an engagement region, e.g. a region with a hook-like or loop-like shape; this is beneficial in that it can facilitate removal of the spittoon from the container by allowing a user's finger to engage with the engagement region (e.g. the hook-like or loop-like region) and lift the spittoon.

A removable lid may be used to close the spittoon, thereby reducing the risk of spilling the contents of the spittoon, e.g. potentially infectious bodily fluids.

In another embodiment, the removable receptacle is a receptacle for holding combat sport equipment. It may be open or it may optionally have a lid. It may, therefore, be a tray or a box. The receptacle can be removed from the container to allow the container to be used as a spittoon and therefore fluids such as phlegm are kept separate from the equipment.

The container may be used with two or more removable receptacles. For example, one removable receptacle may be a spittoon and another removable receptacle may be for holding combat sport equipment (e.g. a tote tray). Optionally the removable receptacle for holding combat sport equipment is adapted to stack with the spittoon, for example it may be adapted to stack on top of the spittoon. It may be that the spittoon has a lid and the removable receptacle for holding combat sport equipment (e.g. tote tray) stacks on top of the spittoon when it has its lid on.

The method of the present invention may comprise the step of providing the container in the form of a kit, wherein the kit comprises the container and one or more removable receptacles. In one embodiment the kit comprises one or more removable receptacle that is a spittoon and optionally the kit may further comprise one or more removable lid adapted to close a corresponding spittoon. In one embodiment the kit comprises one or more removable receptacle that is a receptacle for holding combat sport equipment.

Also provided, according to a second aspect, is a container for holding combat sport equipment, wherein the container comprises: a hollow body defined by four sidewalls that extend from a closed base to an open mouth; and a handle provided on one of the sidewalls of the hollow body, the handle comprising a first elongate member and a second elongate member, wherein: the first elongate member has an elongate axis that lies parallel to the plane of the closed base; and the second elongate member has an elongate axis that lies perpendicular to the plane of the closed base.

The container may also comprise a lid having an inner surface that comprises a flat area, an outer surface, and four edges, wherein one of the edges is pivotally connected to one of the sidewalls of the hollow body and wherein the lid can pivot between an open position, in which the lid does not cover the open mouth and in which the flat area of the inner surface lies parallel to the plane of the closed base, and a closed position, in which the lid partly or completely covers the open mouth.

Also provided, according to a third aspect, is a kit comprising: a container according to the second aspect, and a removable receptacle, wherein the container is adapted to receive the removable receptacle.

A key feature of the present invention is a handle that has a portion to be, in use, grasped in a vertical orientation. The present inventor has determined that a handle that is, in use, grasped in a vertical orientation (by gripping the second elongate member that has an elongate axis that lies perpendicular to the plane of the closed base) provides the benefit of allowing the user to accurately control the orientation of the container, to keep it level and prevent its contents from spilling out, when it is being carried, and when it is being lifted and pushed into a ring.

Another key feature of the present invention is a handle that is in a fixed position relative to the hollow body. The handle cannot move, e.g. by pivoting or telescoping, relative to the body of the container. The first and second elongate members of the handle of the present invention are preferably in a fixed position relative to the hollow body. This provides the benefit that the handle allows the user to accurately control the orientation of the container, to keep it level and prevent its contents from spilling out, when it is being lifted and pushed into a fighting ring.

Another useful feature of certain embodiments of the present invention is the optional removable spittoon. This provides the benefit of allowing different fighters to use the same container with individual spittoons, thereby minimising the risk of transfer of potentially infectious bodily fluids between fighters.

This also provides the benefit of reducing the risk of bodily fluids being spread outside of the spittoon because it is easier for the spittoon alone to be brought closer to the fighter's mouth than for the entire container to be brought closer to the fighter's mouth. In addition, a removable spittoon allows the spittoon to be sanitised more easily and thoroughly than would be possible if the spittoon was part of the container.

Another useful feature of certain embodiments of the present disclosure is the optional lid that has an inner surface that can be used as a work surface. In particular, having a substantially flat and rigid inner surface for the lid permits the use of the inner surface as a work surface. It may be that 50% or more of the area of the inner surface of the lid is rigid and flat, e.g. 75% or more, or 90% or more. Having a work surface on the inner surface of the lid is advantageous because it means that when the work surface is in use, and the lid is in the open position, the contents of the container are accessible.

Having the lid configured and located such that its inner surface is raised off the ground/floor level when it is in an open configuration also assists with the utility as a work surface. In one embodiment the lid comprises a flat area that is substantially co-planar with the open mouth when the lid is in the open position. This configuration provides the advantage that items placed on the work surface are easily accessible and at a convenient height to be used. It has been found to be simpler to stow items placed on the work surface into the container when the work surface is co-planar with the open mouth.

Having a combination of a lid that has an inner surface that is useful as a work surface and a handle that is, in use, grasped in a vertical orientation, is particularly beneficial. Having a combination of a lid that has an inner surface that is useful as a work surface and a handle that is fixed relative to the body of the container is particularly beneficial.

Another useful feature of certain embodiments of the present invention is the optional additional handle or carry strap that extends from one sidewall to an opposing sidewall, across the mouth of the hollow body. This feature allows for a majority of the weight of the container (and its contents) to be transferred through the additional handle and/or strap, whilst the handle on the sidewall of the hollow body can be used to primarily control the movement of the container to prevent its contents from spilling or sloshing out. Thus, this provides the benefit of making the container easier to carry to or from a ring, or into the ring, especially when loaded with equipment.

Another useful feature of the present invention is that the container of the present invention has rigid sidewalls. This has the benefit of maximising space within the container and to enabling the container to be lifted in a stable and controlled manner.

As noted above, traditional devices in the field of combat sports, such as builder's buckets, require the user to lift the bucket onto the edge of the ring and then precariously push the bucket under the ropes with an open palm, risking the bucket sloshing and spilling its contents. In contrast, the present invention allows a user to controllably lift and push the container into the ring with only one hand. This means that a user can carry other equipment in their other hand without the risk of spilling the contents of the container.

Thus, the present invention has a number of technical advantages over methods of holding combat sport equipment using traditional containers.

### DETAILED DESCRIPTION OF THE INVENTION

The method of the present invention uses a specific container as defined herein to hold, and optionally move, combat sport equipment.

The container of the present invention is suitable for holding combat sport equipment. Therefore, the container may be used to assist a combat sport fighter by holding, and optionally moving, combat sport equipment.

Combat sports include but are not limited to: boxing, wrestling, mixed martial arts (MMA), kickboxing, savate, Muay Thai, Sanda, Tae Kwon Do, Capoeira, Brazilian Jiu-jitsu, Historical Medieval Battles (HMB), Sambo, Kyokushin and Kūdō. The present invention will find particular use in combat sports where fights are conducted in a ring, such as boxing, kickboxing, MMA and wrestling.

The equipment may include one or more of the following: towels, sponges, water bottles, energy supplements, ice packs, enswells (anti-swell/bruising irons, also known as no swells) and first aid equipment. First aid equipment may include one or more of the following: cotton wool buds (swabs), bandages, dressings and/or plasters, scissors, latex gloves, chemicals such as petroleum jelly, astringents, ephinephrine and/or clotting agents, and tape.

### Hollow Body

The container of the present invention comprises a hollow body defined by four sidewalls that extend from a closed base to an open mouth.

The hollow body is able to receive and hold equipment.

The closed base can be placed on a floor or other surface. The closed base may have an outer surface that is flat.

The closed base may suitably be square or rectangular in shape. It can be envisaged that the corners of the square or rectangle may be rounded off (curved) or they may be truncated.

The open mouth may suitably be square or rectangular in shape. It can be envisaged that the corners of the square or rectangle may be rounded off (curved) or they may be truncated.

In a preferred embodiment, the closed base and the open mouth are the same size and shape. The container is easier to carry and manoeuvre if it has straight sides. However, it can be envisaged that the closed base and the open mouth might not be identical in size and shape, i.e. they may have a different “footprint”. For example, they could have different sizes, such that the container is tapered. If the container is tapered, it is preferred that the degree of taper is 30 degrees or less, such as 20 degrees or less, or 10 degrees or less. If the mouth is wider than the base, then too high a degree of taper means the container has decreased stability. If the base is wider than the mouth, then too high a degree of taper means the access to contents inside the container is more difficult.

The hollow body may, in one embodiment, be a hollow cubic shape with an open mouth, or a hollow cuboidal shape with an open mouth.

The dimensions of the hollow body are not particularly limited, provided that the hollow body is large enough to contain combat sport equipment and is not so large as to be difficult to lift and handle.

To assist stability it can be desired that the height of the container is not more than twice the width of the closed base, e.g. it may be that the height of the container is not more than 1.5 times the width of the closed base.

In one embodiment the ratio of the height of the container to the width of the closed base is from 1:2 to 2:1, such as from 1:1.5 to 1.5:1, e.g. from 1:1 to 1.5:1.

When the closed base is rectangular, it can be desired that the length of the closed base is not more than three times the width of the closed base, e.g. it may be that the length of the closed base is not more than twice the width of the closed base.

In one embodiment, the hollow body has a height (i.e. the length of each sidewall from the closed base to the open mouth) of 10 cm or more, such as 20 cm or more or 25 cm or more or 30 cm or more. In one embodiment, the hollow body has a height of 100 cm or less, such as 80 cm or less or 60 cm or less. The hollow body may have a height from 20 cm to 100 cm, e.g. from 25 cm to 80 cm or from 25 cm to 65 cm or from 30 cm to 50 cm.

In one embodiment, the closed base has a width of 10 cm or more, such as 20 cm or more or 25 cm or more or 30 cm or more. In one embodiment, the closed base has a width of 100 cm or less, such as 80 cm or less or 60 cm or less. The closed base may have a width from 20 cm to 100 cm, e.g. from 25 cm to 80 cm or from 25 cm to 65 cm or from 30 cm to 50 cm.

In one embodiment, the closed base has a length of 10 cm or more, such as 20 cm or more or 25 cm or more or 30 cm or more. In one embodiment, the closed base has a length of 150 cm or less, such as 100 cm or less or 80 cm or less. The closed base may have a length of from 20 cm to 150 cm, e.g. from 25 cm to 100 cm or from 25 cm to 85 cm or from 30 cm to 70 cm.

In one embodiment, the thickness of each sidewall is from 0.1 mm to 2 cm, e.g. from 0.5 mm to 1 cm.

Preferably, each sidewall is rigid. In other words, preferably each sidewall is not made from a non-rigid material such as fabric. Preferably, the hollow body is rigid, i.e. it has a fixed shape.

### Handle

A handle is provided on one of the sidewalls of the hollow body. The handle comprises a first elongate member and a second elongate member. The first elongate member has an elongate axis that lies parallel to the plane of the closed base. The second elongate member has an elongate axis that lies perpendicular to the plane of the closed base.

An elongate axis of an elongate member is a straight line that runs between its two ends.

In one embodiment the first elongate member has an elongate axis that lies parallel to the plane of the closed base located in the portion of the first elongate member that is closest to the plane of the closed base, e.g. in the lower half of the first elongate member. In one embodiment this portion of the first elongate member comprises a contact surface and, in use, part of the user's hand, e.g. their index finger, can engage with this contact surface of the first elongate member during lifting of the container. In one embodiment, this contact surface of the first elongate member lies in a plane that is parallel to the plane of the closed base.

In one embodiment the second elongate member has an elongate axis that lies perpendicular to the plane of the closed base and that is located in the portion of the second elongate member that is closest to the sidewall from which the handle extends, e.g. in the inner half of the second elongate member. In one embodiment this portion of the second elongate member comprises a contact surface and, in use, part of the user's hand, e.g. one or more of their fingers, can engage with this contact surface of the second elongate member during lifting of the container. In one embodiment, this contact surface of the second elongate member lies in a plane that is perpendicular to the plane of the closed base.

It will be appreciated that the handle is intended to, in use, be gripped by the hand of a user (who is a human and who may be an adult or may be a child over 11, such as a teenager). The handle is therefore positioned on the outer surface of a sidewall of the hollow body, such that the handle is positioned outside of the hollow body.

The handle is preferably in a fixed position relative to the hollow body. In other words, it is preferable that the handle cannot be moved relative to the hollow body. For example, it is preferable that the handle cannot pivot or telescope relative to the hollow body. The handle may be integral with the hollow body or securely attached thereto.

Using a handle that is in a fixed position relative to the body, such that it cannot be moved relative to the hollow body, enables the user to accurately control the orientation of the container, to keep it level and prevent its contents from spilling out, when it is being lifted and pushed into a ring. The user would not be able to control the orientation of the container accurately whilst lifting it and pushing it into a ring if they were to grip a handle that was able to move (e.g. pivot or telescope) relative to the hollow body.

When considering the location of the handle with respect to the width of the sidewall, the handle is preferably located substantially centrally. The location is considered with regard to where the handle contacts the sidewall. Preferably it is located in the middle third of the sidewall, by width (put another way, it may be in a location that is from 33.3% to 66.6% across the width of the sidewall). It may be in the middle 20% of the sidewall, by width (put another way, it may be in a location that is from 4% to 60% across the width of the sidewall). More preferably it is in the middle 10% of the sidewall, by width (put another way, it may be in a location that is from 45% to 55% across the width of the sidewall).

The use of a substantially central location, in terms of the width of the sidewall, means that the handle provides greater control and stability when moving the container.

When considering the location of the handle with respect to the height of the sidewall, the handle is preferably located substantially centrally or in the upper half. The location is considered with regard to where the handle contacts the sidewall. Preferably it is located in the upper two thirds of the sidewall, by height (put another way, it may be in a location that is from 33.3% to 100% up the height of the sidewall, starting from the bottom). It may be in a location that is from 40% to 100% up the height of the sidewall, starting from the bottom, such as from 45% to 100% or from 50% to 100%. In one preferred embodiment it is in a location that is from 40% to 90% up the height of the sidewall, starting from the bottom, such as from 45% to 85% or from 50% to 80%. In another embodiment it is close to the top of the sidewall; e.g. from 70% to 100% up the height of the sidewall, starting from the bottom.

The use of a substantially central or upper half location, in terms of the height of the sidewall, means that the handle provides greater control and stability when moving the container.

If the central base is square, it will be appreciated that all four sidewalls are the same width. If the central base is rectangular, it will be appreciated that two of the four sidewalls have a greater width than the other two. Thus there are two short sidewalls (the end sidewalls) and two long sidewalls (the elongate sidewalls). In this embodiment, it is preferred that the handle is provided on one of the short sidewalls. This provides greater control and stability when moving the container. However, in another embodiment it is envisaged that the handle could be provided on one of the long sidewalls.

The first elongate member may be any shape; for example it may be straight or may be curved or angled. The second elongate member may be any shape; for example it may be straight or may be curved or angled.

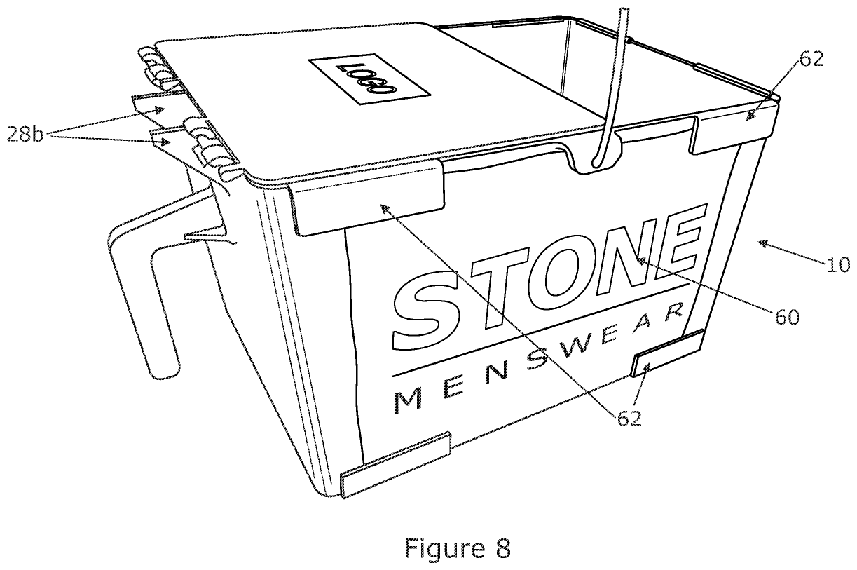

If an elongate member is curved, or is an angled shape (that does not have parallel edges), it will be appreciated that an elongate axis can still be defined as a straight line that runs between its two ends. For example, an elongate member may have an angled shape, e.g. it may be in the shape of a truncated triangle, but it can still have an elongate axis defined as a straight line that runs between its two ends. This can be seen in relation to the first elongate member as shown in the Figures (see, e.g. FIGS. 8, 9 and 10), which has the shape of a truncated triangle, with an angled upper edge and a horizontal lower edge. In this elongate member there is an elongate axis, defined as a straight line that runs between its two ends, which lies parallel to the plane of the closed base, located in the lower half of the elongate member.

In one embodiment, the first elongate member of the handle is directly connected to the outer surface of a sidewall of the hollow body. In one embodiment, the first elongate member of the handle is indirectly connected to the outer surface of a sidewall of the hollow body, i.e. it is connected via one or more additional component parts of the handle. In one embodiment, the first elongate member of the handle is connected to the outer surface of a sidewall of the hollow body via a plate that is directly connected to, or part of, the sidewall.

In one embodiment the second elongate member of the handle is directly connected to the first elongate member. In one such embodiment, the second elongate member is of unitary construction with the first elongate member. In an alternate embodiment, the second elongate member of the handle is indirectly connected to the first elongate member, i.e. it is connected via one or more additional component parts of the handle.

The first member extends from a first end to a second end. Preferably the first end is connected to the sidewall of the hollow body and the second end is connected to the second member.

It will be understood that the first elongate member provides distance between the sidewall of the hollow body to which the handle is attached and the second elongate member. This allows a user to, in use, extend their hand around and grip the second elongate member.

Gripping the second elongate member that has an elongate axis that lies perpendicular to the plane of the closed base enables the user to accurately control the orientation of the container, to keep it level and prevent its contents from spilling out, when it is being lifted and pushed into a ring. The user would not be able to control the orientation of the container as accurately whilst lifting it and pushing it into a ring if they were to grip a member that was parallel to the plane of the closed base. In other words, there is a benefit to the vertical grip arrangement of the present invention.

It is preferred that the plane in which the closed base lies is closer to the second elongate member of the handle than the first elongate member of the handle. Put another way, when considering the container in use, with the closed base on a floor, the first elongate member of the handle extends outwardly away from the container and the second elongate member of the handle preferably extends downwardly away from the first elongate member of the handle, towards the floor.

Therefore the user can grip the second member with their hand and the first member will be above their hand. This means the user can have an upper part of their hand, when it is in a gripping position, in contact with the first member as they lift the container. It may be that user can have part of their index finger in contact with the first member as they lift the container. This arrangement has the benefit of further supporting the weight of the container and any contents as it is lifted. In addition, the contact of part of the user's hand with the first member acts as a stop, and thus securely lodges the user's hand in gripping engagement with the handle. In other words, the user's hand is less likely to slip out of engagement with the handle.

It will be appreciated that there are many shapes that include a first elongate member that has an elongate axis that lies parallel to the plane of the closed base and a second elongate member that has an elongate axis that lies perpendicular to the plane of the closed base. However, simple shapes are preferred, to assist ease of manufacture and ease of use.

In one embodiment, the handle consists essentially of the first elongate member and the second elongate member, e.g. the handle may be an “L” shape. Preferably the “L” shape is upside down in use, as shown here: Γ. In other words, in use the first elongate member may be above the second elongate member.

It may be that the elongate members are straight but it is also envisaged that one or both could be curved or angled shapes.

In one embodiment, the handle consists essentially of the first elongate member and the second elongate member, together with a third elongate member, e.g. the handle may be a “C” shape or a “T” shape. The “T” shape may be upright or may be rotated 90 degrees, as shown here: [symbol] .

It may be that the three elongate members are each straight but it is also envisaged that one, or two, or all three, could be curved or angled shapes.

It will be appreciated that a “C” shape when the three elongate members are each straight is essentially three sides of a square or rectangle, as shown here: ⊐.

In one embodiment, the handle consists essentially of the first elongate member and the second elongate member, together with a third elongate member and a fourth elongate member, e.g. the handle may be an “F” shape.

The handle may, for example, be T-shaped, C-shaped or L-shaped. In one embodiment the handle is L-shaped.

### First Member

The first member extends from a first end to a second end. In one embodiment the first end is connected to the sidewall of the hollow body and the second end is connected to the second member.

The first member spaces the second member of the handle from the sidewall of the hollow body in order that the second member can be gripped by the hand of the user. Therefore, the first member may have a length from its first end to its second end of 1 cm or more, such as 2 cm or more or 3 cm or more. It will be appreciated that for stability and ease of use, however, the second member of the handle should not be too far away from the sidewall of the hollow body. Therefore, the first member may have a length from its first end to its second end of 15 cm or less, such as 10 cm or less or 7 cm or less. The first member may have a length from its first end to its second end of from 1 cm to 15 cm, such as from 2 cm to 10 cm or from 3 cm to 7 cm.

It will be appreciated that the first member should be robustly connected to the sidewall of the hollow body in order to permit secure and controlled movement of the container. It may be that the first member is formed integrally with the sidewall of the hollow body or they may have been separately formed and then attached together.

It will be appreciated that the first member should be robustly connected to the second member in order to permit secure and controlled movement of the container. It may be that the first member is formed integrally with the second member or they may have been separately formed and then attached together.

To assist with robustness, the first member should have a minimum height (the dimension running parallel to the elongate axis of the second member) of 1 cm and a minimum width (the dimension running perpendicular to both the elongate axis of the first member and the elongate axis of the second member) of 1 cm.

Preferably the first member has a minimum height of 2 cm or more, such as 3 cm or more. Preferably the first member has a minimum width of 2 cm or more, such as 3 cm or more.

It will be understood that the first member should be rigid. It should have a fixed shape. In other words, preferably the first member is not made from a non-rigid material such as fabric. Preferably the sidewall to which the first member connects is also rigid, such that it has a fixed shape.

### Second Member

The second member extends from a first end to a second end. In one embodiment the first end is connected to the first member and the second end is freestanding, e.g. in the embodiment where the handle has an upside down “L” shape. In one embodiment the first end is connected to the first member and the second end is connected to a third member, e.g. in the embodiment where the handle has a “C” shape.

In use, the second member is intended to be gripped by the hand of a user. Accordingly, the second member should be sized and shaped such that it can be gripped in a human hand, e.g. an adult human hand.

The cross section of the second elongate member may therefore be any regular or irregular shape that is easy to grip. It may, for example, be circular or oval, or it may be triangular or square or rectangular or pentagonal or hexagonal or octagonal. The cross section may in one embodiment be a shape that is at least partly curved, e.g. it may be circular or oval or it may be a shape with corners that have been rounded off.

The length of the second member should be long enough to permit it to be gripped by the hand of the user. Therefore, the second member may have a length from its first end to its second end of 5 cm or more, such as 7 cm or more or 10 cm or more. It will be appreciated that for stability and ease of use, however, the second member of the handle should not be too long. Therefore, the second member may have a length from its first end to its second end of 30 cm or less, such as 25 cm or less or 20 cm or less. The second member may have a length from its first end to its second end of from 5 cm to 30 cm, such as from 7 cm to 25 cm or from 10 cm to 20 cm.

To assist with robustness, the second member should have a minimum depth (the dimension running parallel to the elongate axis of the first member) of 1 cm and a minimum width (the dimension running perpendicular to both the elongate axis of the first member and the elongate axis of the second member) of 1 cm.

Preferably the second member has a minimum depth of 2 cm or more, such as 3 cm or more. Preferably the second member has a minimum width of 2 cm or more, such as 3 cm or more.

It will be understood that the second member should be rigid. It should have a fixed shape. In other words, preferably the second member is not made from a non-rigid material such as fabric.

### Lid

The container may optionally be provided with a lid having an inner surface that comprises a flat area, an outer surface, and four edges. One of the edges is pivotally connected to one of the sidewalls of the hollow body. The lid can pivot between an open position, in which the lid does not cover the open mouth and in which the flat area of the inner surface lies parallel to the plane of the closed base, and a closed position, in which the lid partly or completely covers the open mouth.

Preferably the lid, when in an open position, presents the inner surface at a raised location, i.e. above the ground/above floor-level. One of the edges of the lid may be pivotally connected to the edge of the sidewall that defines part of the mouth of the hollow body. Therefore when the closed base is placed on a floor, one of the edges is pivotally connected to the uppermost edge of the sidewall. This means that, when the lid is in the open position, the work surface will be substantially co-planar with, i.e. level with, the open mouth. This configuration provides the advantage that items placed on the work surface are easily accessible and at a convenient height to be used. Furthermore, it is straightforward to stow items placed on the work surface into the container with this configuration whereby, in use, the work surface is raised above floor-level.

When the lid is in the closed position, the inner surface faces towards the closed base of the hollow body and the outer surface faces away from the closed base of the hollow body. Put another way, when the closed base is placed on a floor, the inner surface faces downwardly and the outer surface faces upwardly.

When the lid is in the open position the inner surface faces away from the closed base of the hollow body and the outer surface faces towards the closed base of the hollow body. Put another way, when the closed base is placed on a floor, the inner surface faces upwardly and the outer surface faces downwardly.

The inner surface of the lid comprises a flat area which, in use, provides a work surface. It will be understood that a work surface should be substantially rigid. It will be appreciated that the inner surface of the lid may also comprise surface features, such as grooves, texturing, indentations and/or protrusions. These may, for example, increase the traction of objects upon the work surface or may serve to delineate one area of the work surface from another. Therefore the work surface comprises a flat area, but need not be flat across its entirety. In one embodiment, however, the work surface is flat.

It may be that all of the inner surface of the lid forms a work surface or it may be that only part of the inner surface of the lid forms a work surface. It is preferred that 50% or more of the area of the inner surface of the lid forms a work surface, e.g. 75% or more or 90% or more. In one embodiment, all of the inner surface is flat.

In the closed position the lid partly or completely covers the open mouth. In one embodiment the lid completely covers the open mouth, i.e. in the closed position the box is closed and its contents cannot be accessed. In one embodiment the lid partly covers the open mouth, i.e. in the closed position the box is only partly closed and some or all of its contents can still be accessed.

It may be that the hollow body is divided into two or more compartments, and at least one compartment is covered by the lid in the closed position and at least one compartment is not covered by the lid when in the closed position. This allows the user to access some but not all of the compartments when the lid is in the closed position. It may be that the compartment that can be accessed is emptied so that it includes no equipment, and this compartment can then be used as a spittoon. The benefit of this configuration is that the lid covers the other compartment or compartments, and so keeps them closed, and thus equipment contained within these compartments does not become contaminated with fluids intended for the spittoon.

In one embodiment, the inner surface of the lid includes one or more sidewall running along an edge of the lid. The lid may include one or two or three or four such sidewalls. In one embodiment, the lid includes sidewalls on all edges except for the edge that pivotally connects to one of the sidewalls of the hollow body. This embodiment allows for items held upon the work surface to be stowed quickly, e.g. when the corner man has to leave the ring, by pivoting the lid so that it tilts towards a closed position, as the sidewalls of the lid can funnel the items into the container.

The lid may, in the closed position, cover 25% or more of the area of the mouth, such as 40% or more, or 50% or more. In one embodiment the lid, in the closed position, covers all of the area of the aperture. The lid may, in the closed position, cover 80% or less of the area of the mouth, such as 60% or less. The lid may, in the closed position, cover from 25% to 100% of the area of the mouth, such as from 40% to 80%. In one embodiment the lid covers from 50% to 60% of the area of the mouth.

In one embodiment, in the closed position the lid covers all of the width of the mouth (the dimension of the edge that is pivotally connected with a sidewall of the hollow body).

In one embodiment, in the closed position the lid covers some or all of the length of the mouth (the dimension of the edge that extends perpendicular to the pivotal connection with a sidewall of the hollow body). It may cover from 25% to 100% of the length of the mouth, such as from 40% to 80% or from 50% to 60%.

In one embodiment the lid is pivotally connected to the sidewall that is provided with the handle.

In one embodiment the lid is pivotally connected to a sidewall by one or more hinge, e.g. by a pair of spaced apart hinges.

The extent to which the lid can pivot is limited, to stop the lid from pivoting past the open position. It will be appreciated that in the open position the inner surface of the lid lies parallel to the plane of the closed base, such that in use it is level with the floor, and so normally will be horizontal.

In a preferred embodiment a stop is provided, to prevent the lid from pivoting past the open position. The stop may comprise one or more protrusions on the sidewall that is pivotally connected to an edge of the lid. The outer surface of the lid will come into engagement with the stop, and the lid will be prevented from pivoting further. In one embodiment the stop comprises a pair of spaced apart protrusions.

It will be appreciated that lid will engage with and be supported by the stop when it is in the open position.

When the lid is in the closed position, the lid may engage with and be supported by one or more of the sidewalls and/or one or more partitions within the hollow body. This may be by direct contact, or the contact may be indirect, e.g. the lid may contact one or more protrusions extending from the sidewalls and/or partitions within the hollow body.

In one embodiment the thickness of the lid, i.e. the distance between the inner surface and outer surface, is from 1 mm to 2 cm, such as from 5 mm to 1 cm.

In one embodiment the lid is removable, to facilitate cleaning of the container. In another embodiment the lid is permanently attached to the hollow body.

In one embodiment, the container does not have a lid.

### Partition Walls

It will be appreciated that the hollow body may optionally be partitioned into two or more compartments. The hollow body may, for example, be partitioned into three or more compartments. In one embodiment there are two or three compartments.

One or more partition walls may therefore be included inside the hollow body.

A compartment may be defined by part of the closed base together with one or more sidewalls or parts thereof and one or more partition walls or parts thereof.

A compartment will have an open mouth at the opposite end to its closed base.

In on embodiment, a compartment may be rectangular or square in cross section. It may suitably have the same cross section from its open mouth to its closed base.

In the optional embodiment where there is a lid, it may be that the hollow body is divided into two or more compartments, and at least one compartment is covered by the lid in the closed position and at least one compartment is not covered by the lid when in the closed position. This allows the user to access some but not all of the compartments. It may be that the compartment that can be accessed when the lid is in the closed position is emptied so that it includes no equipment, and this compartment can then be used as a spittoon. The benefit of this configuration is that the lid covers the other compartment or compartments, and so keeps them closed, and thus equipment contained within these compartments does not become contaminated with fluids intended for the spittoon.

In the optional embodiment where there is a lid, it may, for example, be that there are two or more compartments that are covered by the lid in the closed position and at least one compartment that is not covered by the lid when in the closed position.

In one embodiment there is no lid and therefore all of the compartments are open.

### Removable Receptacle

The container may be adapted to receive one or more removable receptacles, such as a spittoon and/or an insert tray and/or a storage box. Preferably the container is used with one or more removable receptacles, wherein the container is adapted to receive at least one removable receptacle.

In one embodiment the hollow body includes a compartment that is adapted to receive a removable receptacle.

The removable receptacle may be generally cuboidal in shape, i.e. having two shorter sides and two longer sides. However, other shapes could be used.

In one embodiment, the container is provided together with one or more removable receptacle. The one or more removable receptacle may be selected from the group consisting of spittoons, insert trays and storage boxes, and combinations thereof.

The removable receptacle may be an open receptacle, e.g. a tray. The tray may be a “tote” tray, i.e. a tray having one or more compartments and a fixed central handle enabling the user to lift and carry the tray.

The removable receptacle may be a closed receptacle, e.g. a box. Therefore the receptacle comprises a closed-end hollow body with an open mouth and with a lid for closing the mouth. In one embodiment, the storage box is an air-tight storage box. It will be understood that the storage box will be useful for storing equipment that is especially sensitive to contamination, such as first aid equipment.

In one preferred embodiment, the container is provided together with a removable receptacle that is a spittoon. It will be understood that the spittoon has a closed-end hollow body, which can contain and retain fluids, and an open mouth. The spittoon may be any suitable size and shape. The spittoon may have a hollow body defined by four sidewalls that extend from a closed base to an open mouth. The distance from the closed end of the spittoon to the open mouth of the spittoon may be 4 cm or more, such as 6 cm or more, or 8 cm or more, for example from 4 cm to 20 cm, or from 6 cm to 15 cm.

The spittoon may include a handle, which may be elongate. Usefully at least part of the handle extends away from the open mouth of the spittoon, to provide a portion of the handle that a user can easily engage with, e.g. using their finger or hand. In one embodiment at least part of the handle extends vertically away from the open mouth, e.g. running substantially parallel to a sidewall of the spittoon. For example, the handle may extend 3 cm or further beyond the open mouth of the spittoon, such as 4 cm or further, or 5 cm or further, such as from 3 cm to 20 cm, or from 3 cm to 15 cm or from 5 cm to 10 cm beyond the open mouth of the spittoon.

Where the spittoon is cuboidal the handle may extend from one of the shorter sidewalls or from one of the longer sidewalls of the hollow body of the spittoon. In one preferred embodiment the elongate handle extends from one of the longer sidewalls of the hollow body of the spittoon. In one preferred embodiment the elongate handle extends from a position approximately half way along a sidewall of the hollow body of the spittoon.

The handle may have an engagement region, e.g. with a hook-like or loop-like shape, to facilitate removal of the spittoon from the container; for example by allowing a user to retrieve the spittoon from the container by engaging a finger with the engagement region (e.g. hook-like or loop-like region). Preferably the handle is elongate and the engagement region is located at a distal end of the handle from the hollow body of the spittoon.

A removable lid may be provided that can be used to close the open mouth of the spittoon. This can, therefore, reduce the risk of spilling the contents of the spittoon, e.g. potentially infectious bodily fluids. The lid may include a recess that, when the lid is on the receptacle, allows the handle to extend beyond the lid. The lid may form a fluid-tight seal with the open mouth of the spittoon.

A plurality of spittoons may be provided. These may be adapted to stack with one another, e.g. to reduce space consumption and/or facilitate transportation.

In one embodiment the plurality of spittoons are adapted so that each spittoon can fit partially within the hollow body of another spittoon, therefore permitting a stack of two or more spittoons to be formed.

In one embodiment whereby the container is adapted to receive a removable receptacle, the removable receptacle is intended to sit on the closed base of the hollow body of the container. Therefore in this embodiment there is no additional feature present in the hollow body of the container to facilitate the use of the removable receptacle; it is just required that the removable receptacle is sized and shaped such that it can fit inside the hollow body or a compartment thereof.

In one such embodiment the receptacle is sized and shaped such that the removable receptacle is secure (substantially prevented from moving out of position) within the hollow body of the container, or a compartment thereof, during transportation. Such prevention of movement will reduce the likelihood of any of the removable receptacle contents (e.g. potentially infectious bodily fluids) spilling or sloshing out whilst the container is being moved. For example, the internal dimensions separating the sidewalls of the hollow body of the container, or the compartment thereof, may be larger than the external dimensions of the removable receptacle by 2 cm or less, such as 1 cm or less, or 0.5 cm or less. It will be understood that some space may need to be left surrounding the receptacle such that the receptacle can be removed from the container.

In another embodiment whereby the container is adapted to receive a removable receptacle, the container may include one or more support members and the removable receptacle can be placed inside the container so as to engage with, and be supported on, said support members. In one embodiment, the support members hold the removable receptacle at a distance (such as 2 cm or more, e.g. 5 cm or more) from the closed base of the hollow body.

In one such embodiment, the hollow body includes a compartment intended for use as a spittoon and the support members are located such that the removable receptacle can be placed in said compartment but held at a distance (such as 2 cm or more, e.g. 5 cm or more) from the closed base of the hollow body. Therefore the removable receptacle can be removed before the compartment is used as a spittoon and after the compartment has been used as a spittoon, and so contains liquid, the removable receptacle can be replaced into the compartment but is held above the liquid.

Where there are support members, these may be a plurality of fins, each of which extends from the inner surface of a sidewall or from a partition wall. The removable receptacle can engage with, and be supported on, two or more fins. The support members may alternatively or additionally comprise a plurality of arms, each of which extends from the inner surface of a sidewall or from a partition wall. The removable receptacle can engage with, and be supported on, two or more arms. The support members may alternatively or additionally comprise a ledge and the removable receptacle can engage with, and be supported on, the ledge. The ledge may be provided on an inner surface of one or more of the sidewalls.

### Carry Aids

The container may be provided with one or more carry aids. This may be an additional handle and/or a strap.

The additional handle or strap may extend from one sidewall to an opposing sidewall, across the mouth. This allows a majority of the weight of the container to be transferred through the additional handle and/or strap, whilst the handle on the sidewall of the hollow body can be used to control the movement of the container past the ropes of a ring once the weight of the container is supported by the floor of the ring.

It will be appreciated that an additional handle will be beneficial if the user intends to carry the container by hand. The additional handle may comprise an arm and a grip. The additional handle may be made of a plastic (such as polypropylene) and/or a metal or alloy (such as steel or stainless steel). The additional handle may suitably extend from one sidewall to an opposing sidewall across the mouth at a substantially central location, i.e. it extends from a position on one sidewall that is about halfway along its length to a position on the opposing sidewall that is about halfway along its length. The additional handle may be curved, e.g. it may be similar to a conventional bucket handle, or it may comprise straight sections, e.g. it may be a shape that is essentially three sides of a square or rectangle.

Furthermore an additional handle that extends from one sidewall to an opposing sidewall across the mouth has benefits when lifting and pushing the container into a ring.

The user will be able to predominantly use the additional handle to lift the weight of the container with one hand, allowing them to use their other hand to grip the handle provided on one of the sidewalls of the hollow body to control the movement of the container and to keep the container level. Since the user's hand that holds the handle provided on one of the sidewalls of the hollow body is now focused on controlling the movement of the container, rather than supporting its weight, the user will find it even easier to keep the container level and to control its motion into the ring.

Once a part of the closed base of the container has been rested upon the ring, the user will be able to release the additional handle and push the container into the ring and past the ropes using the handle provided on one of the sidewalls of the hollow body. Thus, the user can still lift and push the container into the ring in one smooth and controlled movement that significantly reduces the risk of spilling or sloshing the contents of the container.

It will be appreciated that a strap will be beneficial if the user intends to carry the container on their shoulder.

The strap may comprise a fastening (such as a buckle or a clip) and/or a padded section. The strap may be made of leather, and/or a synthetic fabric (such as nylon) and/or a natural fabric (such as cotton or linen). The strap could extend diagonally across the mouth, from corner to corner, or could extend from one sidewall to an opposing sidewall across the mouth. In the latter case, it may suitably extend from one sidewall to an opposing sidewall across the mouth at a substantially central location, i.e. it extends from a position on one sidewall that is about halfway along its length to a position on the opposing sidewall that is about halfway along its length.

In one embodiment, the container may include attachment members that can be used to releasably secure an optional additional handle or strap to the container, with this additional handle extending across the open mouth of the container. These may, for example, be holes via which an additional handle or strap can be secured.

### Movement Aids

The container may be provided with one or more movement aids to facilitate movement of the container along the floor of a ring. These may be, for example, wheels, rollers and/or casters.

The container may, for example, be provided with movement aids on the outer surface of the closed base of the hollow body.

In one embodiment, the container may have one or more (e.g. two or more) wheels, rollers and/or casters provided on the closed base end of the hollow body, towards the sidewall opposite the sidewall provided with the handle. These wheels, rollers and/or casters may be positioned such that when the handle is lifted these movement aids enable the container to move easily across the floor.

### Fluid Outlet

In one embodiment the hollow body includes a fluid outlet, such as a hole and/or tube. This is suitably located in the closed base, or in a sidewall at a location close to the closed base.

Therefore fluids can be drained from the container out of the fluid outlet. This is useful if the container is used as a spittoon, or if there is water or other fluids within the container. The fluid outlet may be particularly useful when draining the container and/or cleaning the container, e.g. by washing it out with water or other cleaning fluids.

The fluid outlet may optionally be provided with a closure, such as a plug, bung, tap and/or valve, to allow fluids to be drained from the container only when desired by the user.

In one embodiment, the closure is provided such that it is operated from outside of the container. This feature has the advantage that the user can remove a fluid from the container without having to come into contact with the fluid. This is particularly advantageous when the fluid comprises bodily fluids such as phlegm or blood, whereby contact with the fluid represents a health and safety problem.

Therefore, for example, in one embodiment there may be a hole and an associated plug, whereby the plug engages with and stops the hole from the outside of the container. Thus the user can remove the plug from the hole, to permit fluid to flow out of the hole, whilst keeping their hands outside of the container.

In another embodiment, there may be a hole and an associated tap located outside the container that can be closed to stop fluid flow out of the hole, and opened to permit fluid flow out of the hole.

In another embodiment, there may be a tube that extends outwardly from the container and an associated bung, tap and/or valve located outside the container that can be closed to stop fluid flow out of the tube, and opened to permit fluid flow out of the tube.

### Advertisement Holders

Combat sports may be funded, in part, by advertising. Therefore, in one embodiment one or more of the sidewalls (i.e. one, two, three or four sidewalls) includes a holder for an advertising sign. This is provided on the outer surface of the sidewalls, such that the advertising sign is visible during normal use of the container.

The holder may be configured for holding an advertising sign (which may be made of paper, card, plastic, textile or other material) to the sidewall of the container whilst substantially not obstructing the view of the paper or card.

The holder may, for example, include slots or sleeves for receiving an edge or a corner of an advertising sign. There may be two or more, such as four or more, slots or sleeves for each receiving an edge or a corner of an advertising sign.

### Manufacture and Materials

The material that the container of the present invention is manufactured from is not particularly limited, so long as it can perform the intended function of the container.

It is desired that the container is able to retain liquids during use, so that the container can be used as a spittoon, or is able to contain other fluids such as water, sweat or blood. Therefore the material to be used should suitably be water impermeable.

It is desired that the container is portable. Therefore the material to be used should suitably be lightweight.

The container should have the strength to be able to hold equipment of the type used in combat sports, and the material should be selected with this in mind.

In one embodiment, the container is manufactured from plastic (such as polypropylene), or metal or alloy (such as steel or stainless steel). Preferably the container is manufactured from plastic, such as polypropylene, due to the light weight and high strength of such materials. However, it will be appreciated that the invention is not limited to specific materials.

The container of the present invention may be made by various processes that will be immediately apparent to the skilled person. For example, the container may be made using injection moulding or vacuum forming techniques.

### DETAILED DESCRIPTION OF THE DRAWINGS

An embodiment of the present invention will now be described, by way of example only, with reference to the accompanying drawings, in which:

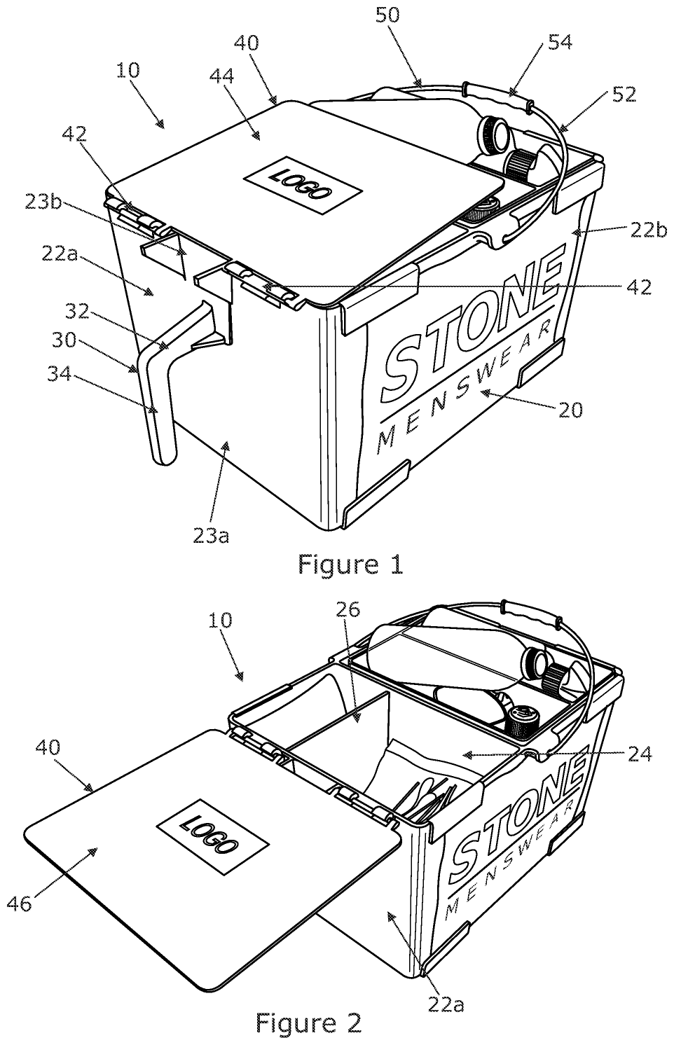

FIG. 1 is a perspective view of a container according to the present disclosure;

FIG. 2 is a perspective view of the container shown in FIG. 1, wherein the lid is in the open position;

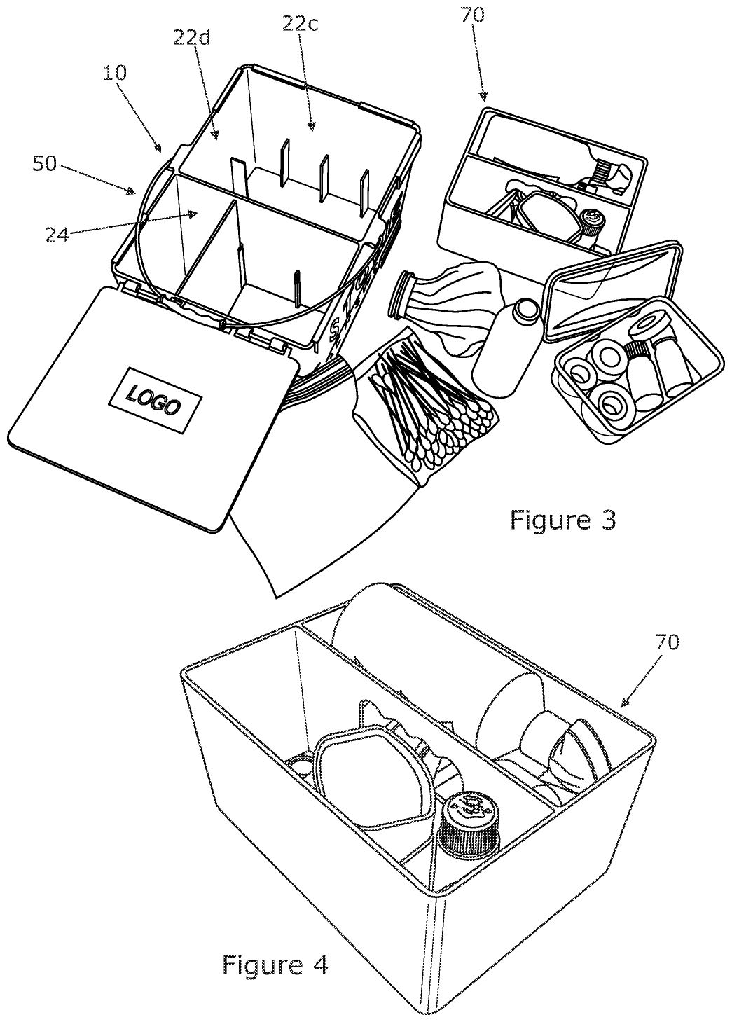

FIG. 3 is a perspective view of the container shown in FIGS. 1 and 2, wherein the equipment contained within the container and the insert tray have been unpacked;

FIG. 4 is a perspective view of an insert tray of the container shown in FIGS. 1 to 3;

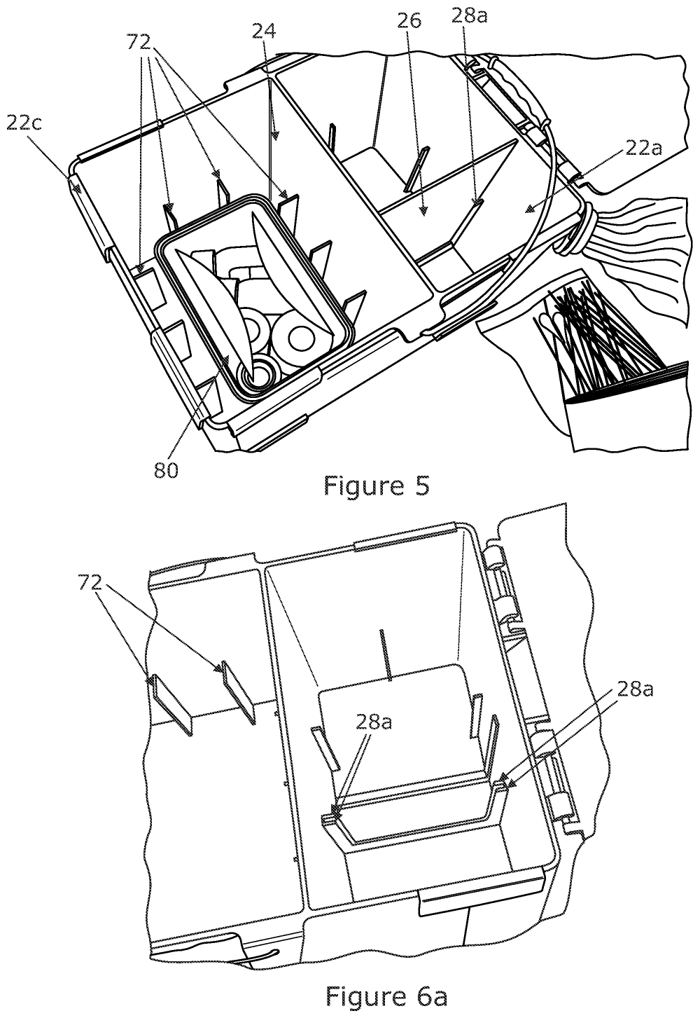

FIG. 5 is a perspective view of the container shown in FIGS. 1 to 3, showing a storage box inside the container, in a first compartment of the hollow body;

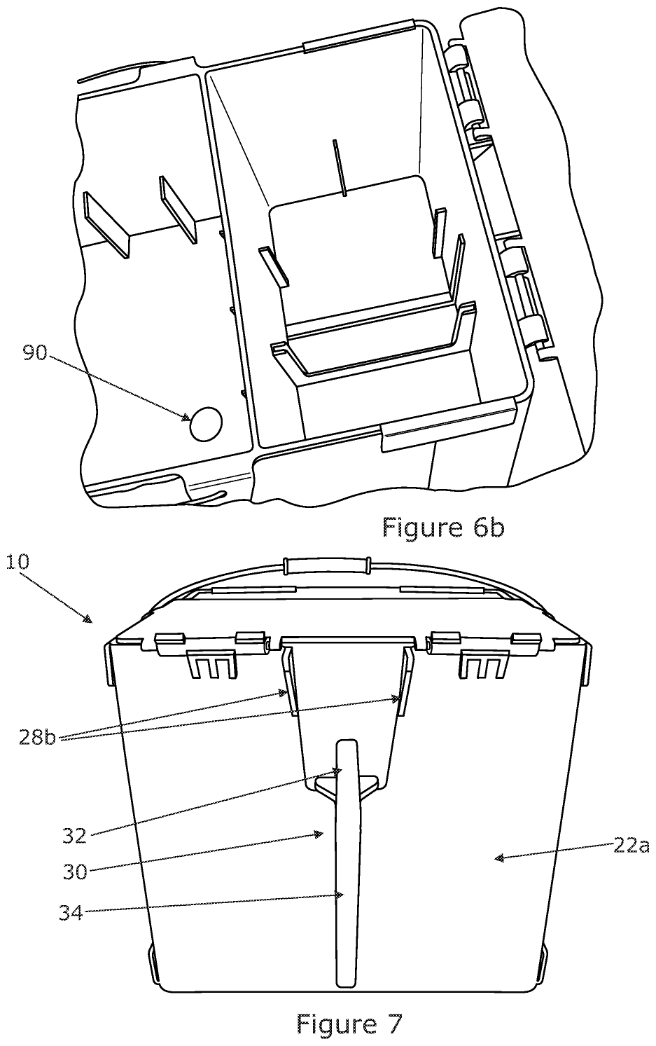

FIG. 6a is a perspective view of the container shown in FIGS. 1 to 3 and FIG. 5, predominantly showing the inside of a second compartment of the hollow body;

FIG. 6b is a perspective view of an alternative embodiment of the container shown in FIGS. 1 to 3 and FIG. 5, which is provided with a fluid outlet in the closed base of the first compartment of the hollow body;

FIG. 7 is a perspective view from the outside of the container shown in FIGS. 1 to 3 and FIGS. 5 and 6, showing the handle of the container in more detail;

FIG. 8 is a perspective view of the container shown in FIGS. 1 to 3 and FIGS. 5 to 7, wherein the lid is in the closed position;

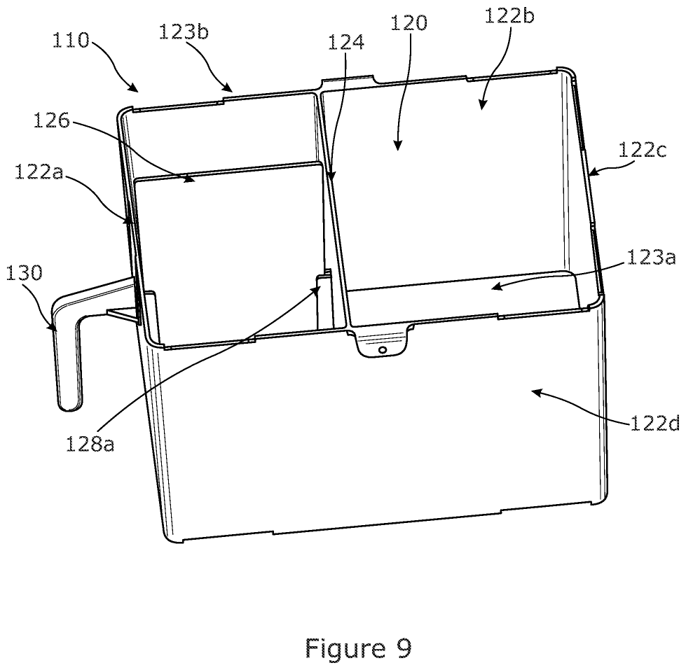

FIG. 9 is a perspective view from above of an alternative container according to the present disclosure;

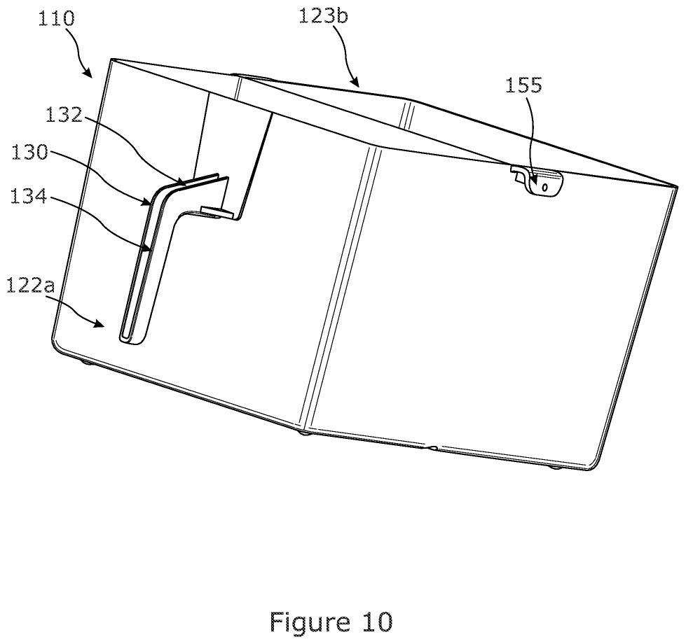

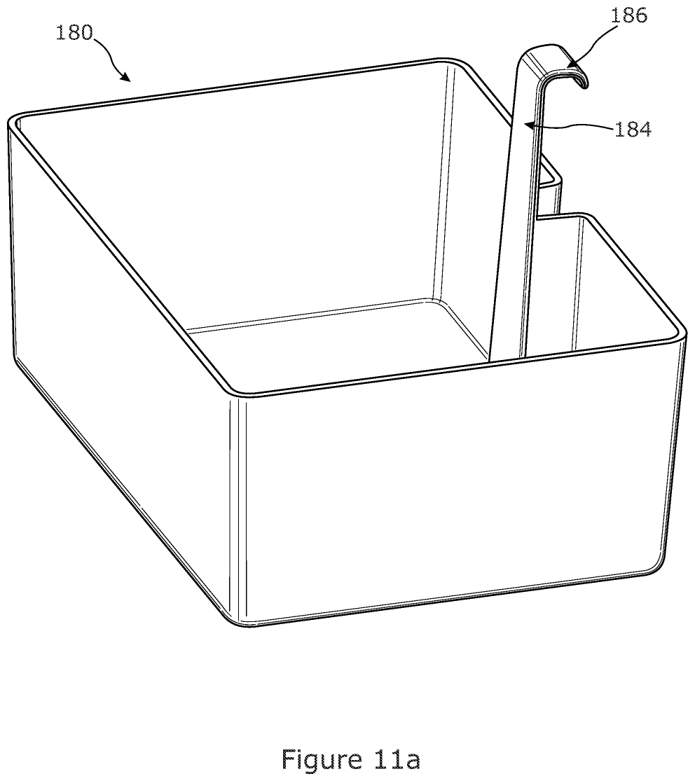

FIG. 10 is a perspective view from the handle end of the container shown in FIG. 9;

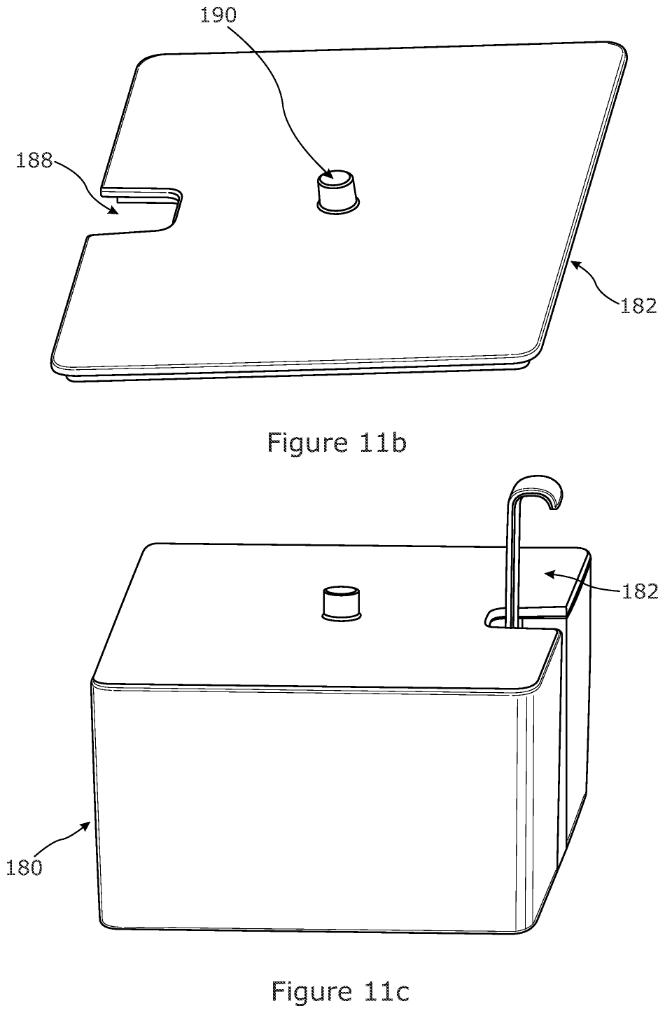

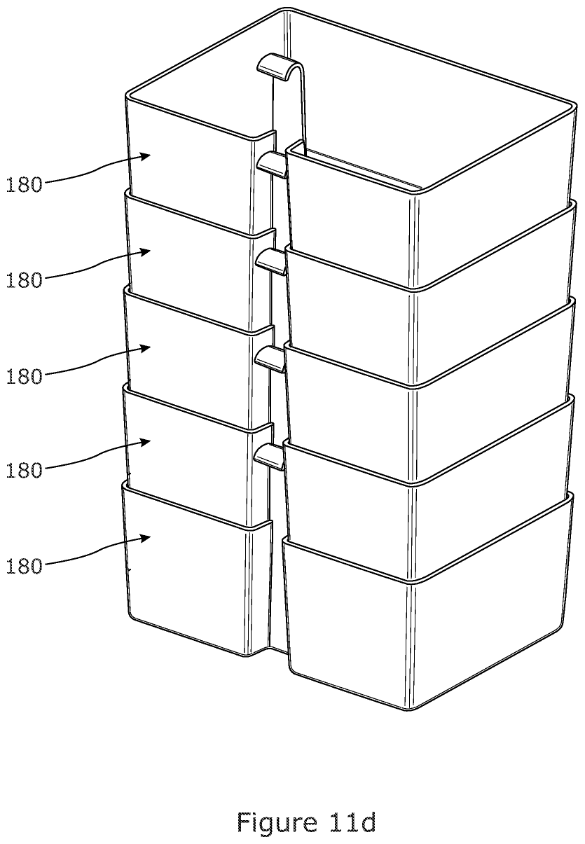

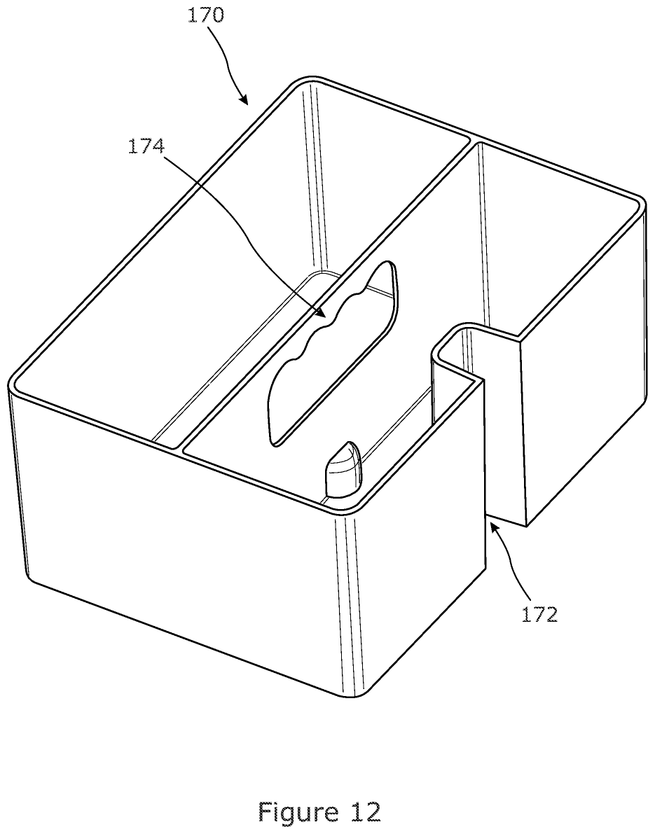

FIG. 11a is a perspective view of a spittoon that can be used with a container according to the present disclosure;

FIG. 11b is a perspective view of a lid for the spittoon shown in FIG. 11a;

FIG. 11c is a perspective view of the spittoon shown in FIG. 11a when provided with the lid of FIG. 11b;

FIG. 11d is a perspective view of a plurality of spittoons of the type shown in FIG. 11a in the form of a stack;

FIG. 12 is a perspective view of an insert tray that can be used with a container according to the present disclosure;

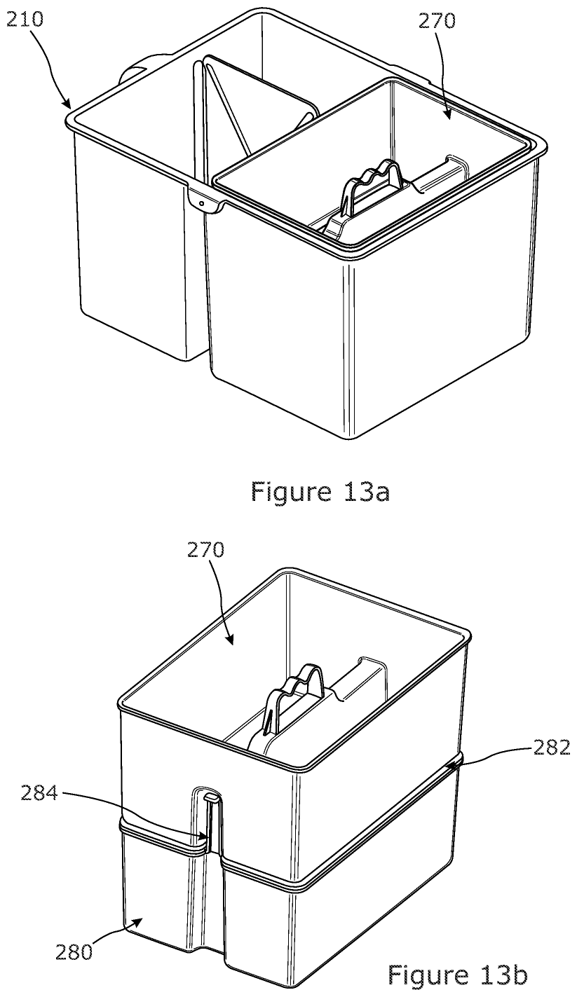

FIG. 13a is a perspective view of an alternative container according to the present disclosure, in which an insert tray of the type shown in FIG. 12 can be seen; and

FIG. 13b is a perspective view of an insert tray stacked on top of a spittoon with a lid.

FIG. 1 of the accompanying drawings shows a container 10 according to the present disclosure that comprises a hollow body 20 defined by four sidewalls 22 (22a-22d) that extend from a closed base 23a to an open mouth 23b. The hollow body 20 is generally cuboidal. The closed base 23a supports the body 20 on the floor.

The container 10 also comprises an L-shaped handle 30 that is integral with sidewall 22a of the hollow body. The handle 30 is located substantially centrally with respect to the width of sidewall 22a, and is in the upper half with respect to the height of sidewall 22a. This provides greater control and stability when moving the container 10. The handle 30 has a first elongate member 32 and a second elongate member 34. The first member 32 separates the second member 34 from the sidewall 22a. The second member 34 is designed to be gripped by the hand of the user. When the second member 34 is gripped by the hand of the user their index finger suitably rests against the first member 32. The “L” shape is upside down in use, as shown here: F. In other words, in use the first elongate member 32 is above the second elongate member 34.

The container is also shown as including a lid 40. Lid 40 is an optional feature of the container used in the method of the present invention and therefore can be omitted. The lid 40 is pivotally connected to the hollow body 20 by two hinges 42. FIG. 1 shows the outer surface 44 of the lid 40.

The container also includes an additional handle 50 that extends across the open mouth 23b from one sidewall 22b to an opposite sidewall 22d and can move pivotally, in the manner of a traditional bucket handle. The additional handle 50 comprises a metal arm 52 and a plastic grip 54.

FIG. 2 of the accompanying drawings shows the lid 40 in the open position. The inner surface 46 of the lid 40 is shown in FIG. 2, and provides a flat work surface.

From FIGS. 1 and 2 it can be appreciated that when the lid 40 was in the closed position it covered the mouth 23b. In this position the lid 40 extended over a first partition wall 24. A first compartment is defined by first partition wall 24, sidewall 22a and part of sidewalls 22b and 22d. This first compartment can be split into two by second partition wall 26.

FIG. 3 of the accompanying drawings shows the container 10 with the lid 40 in the open position and with the contents of the container, including an insert tray 70, unloaded. The additional handle 50 now rests on the hinges 42 of the lid 40, showing that the additional handle 50 is pivotable.

In FIG. 3, sidewalls 22c and 22d are visible. In addition, it can be seen that the container was provided with an insert tray 70. The insert tray is sized to be received in a second compartment defined by sidewall 22c, partition wall 24 and part of sidewalls 22b and 22d.

The insert tray 70 is shown in more detail in FIG. 4 of the accompanying drawings. The insert tray 70 is a “tote” tray. The insert tray 70 is used to store equipment and can be removed from and re-inserted into the container 10.

FIG. 5 of the accompanying drawings shows the second compartment defined by sidewall 22c, partition wall 24 and part of sidewalls 22b and 22d. The insert tray 70 is sized to fit into this compartment, and the insert tray 70 is supported by a plurality of fin-shaped support members 72 when it is inserted into the compartment.

FIG. 5 of the accompanying drawings also shows the first compartment defined by sidewall 22a, partition wall 24 and part of sidewalls 22b and 22d. This first compartment can be split into two by second partition wall 26.

It can be seen that partition wall 26 is held in place by partition holders 28a extending from sidewall 22a and partition wall 24. The partition holders 28a are shown in more detail in FIG. 6a of the accompanying drawings, where partition wall 26 has been removed. The four partition holders 28a are arranged so as to define two opposing channels into which partition wall 26 can be releasably secured.

FIG. 6b shows an alternative embodiment of the container 10 which is provided with a hole 90 in the closed base to act as a fluid outlet. Specifically, the hole 90 is located in the closed base 23a of the second compartment defined by sidewall 22c, partition wall 24 and part of sidewalls 22b and 22d. Fluids can be drained from the container 10 out of the fluid outlet 90. The fluid outlet 90 is useful for when the container 10 is used as a spittoon, or if there is water or other fluids within the container. Therefore, the fluid outlet 90 may be particularly useful when draining and/or cleaning the container 10.

A closure (not shown), such as a plug, is provided to removably seal the hole 90. Therefore fluids can be retained in the container 10 when desired, and can subsequently be drained from the container 10 when desired. The closure, e.g. plug, engages with the hole 90 from outside the container 10, which has the advantage that the user can take the plug out of the hole 90 without having to place their hand inside the container 10 and therefore they do not need to come into contact with any fluid inside the container 10.

FIG. 7 of the accompanying drawings shows a perspective view of sidewall 22a. The handle 30, including first member 32 and second member 34, can be seen. In addition, it can be seen that two protrusions 28b extend from sidewall 22a. The protrusions 28b act as a stop and support the lid 40 relative to sidewall 22a of the hollow body 20 when the lid 40 is in the open position, thereby preventing the lid 40 from pivoting past the open position.

FIG. 8 of the accompanying drawings shows a perspective view of the container 10 shown in FIGS. 1-3 and 5-7, wherein the lid 40 is in the closed position. In addition, this view shows the two “stop” protrusions 28b in more detail. It can also be seen that the container includes an advertisement holder 60 that comprises four sleeves 62 for holding an advertising sign.

It can be seen that the first compartment as defined by first partition wall 24, sidewall 22a and part of sidewalls 22b and 22d (which can be split into two by second partition wall 26) is covered by the lid in the closed position. Meanwhile, the second compartment as defined by sidewall 22c, partition wall 24 and part of sidewalls 22b and 22d is not covered by the lid when in the closed position. This means that when the lid 40 is in the closed position the user can only access the second compartment. This second compartment can be emptied so that it includes no equipment, and this compartment can then be used as a spittoon. This configuration means that the lid 40 covers the first compartment (optionally split into two), and so keeps it closed, and thus equipment contained within this first compartment does not become contaminated with fluids intended for the spittoon.

FIG. 9 of the accompanying drawings shows a container 110 according to the present disclosure. The container comprises a hollow body 120 defined by four sidewalls 122 (122a-122d) that extend from a closed base 123a to an open mouth 123b. The hollow body 120 is generally cuboidal. The closed base 123a supports the body 120 on the floor.

The container 110 also comprises an L-shaped handle 130 that is integral with sidewall 122a of the hollow body.

FIG. 10 of the accompanying drawings shows that the handle 130 is located substantially centrally with respect to the width of sidewall 122a, and is in the upper half with respect to the height of sidewall 122a. This provides greater control and stability when moving the container 110. The handle 130 has a first elongate member 132 and a second elongate member 134. The first member 132 separates the second member 134 from the sidewall 122a. The second member 134 is designed to be gripped by the hand of the user. When the second member 134 is gripped by the hand of the user their index finger suitably rests against the first member 132. The “L” shape is upside down in use, as shown here: F. In other words, in use the first elongate member 132 is above the second elongate member 134.

The container as shown also includes attachment members 155, located substantially centrally with respect to the width of sidewalls 122b and 122b, such that these are provided opposite one another on either side of open mouth 123b. These attachment members 155 include holes and can be used to releasably secure an optional additional handle or strap (not shown) to the container 110, with this additional handle or strap extending across the open mouth 123b.

Referring again to FIG. 9, it can be seen that a first compartment is defined by first partition wall 124, sidewall 122a and part of sidewalls 122b and 122d. This first compartment can be split into two by second partition wall 126. It can be seen that partition wall 126 is held in place by partition holders 128a extending from sidewall 122a and partition wall 124. Four partition holders 128a are arranged so as to define two opposing channels into which partition wall 126 can be releasably secured.

A second compartment is defined by first partition wall 124, sidewall 122c and part of sidewalls 122b and 122d.

FIG. 11a of the accompanying drawings shows spittoon 180, which has an elongate handle 184 that extends vertically from the open mouth of spittoon 180. The handle 184 has an engagement region with a hook-like shape 186 to facilitate removal of spittoon 180 from the second compartment of container 110. Spittoon 180 is generally cuboidal and handle 184 extends from a position half way along one of the longer sidewalls of spittoon 180.

FIG. 11b of the accompanying drawings shows spittoon lid 182, which is adapted to fit on spittoon 180. The lid 182 has a notch 188 to fit around the spittoon handle 184. The lid 182 also has a central projection 190 to assist the user with holding, lifting and moving the lid 182.

FIG. 11c of the accompanying drawings shows spittoon lid 182 positioned on spittoon 180. A fluid-tight seal can be formed between spittoon 180 and lid 182. This reduces the risk of spilling the contents of spittoon 180, e.g. potentially infectious bodily fluids.

FIG. 11d of the accompanying drawings shows that a plurality spittoons 180 are able to stack with one another to reduce space consumption and facilitate transportation.

FIG. 12 of the accompanying drawings shows more detail of insert tray 170. The insert tray 170 is a “tote” tray. The insert tray 170 is used to store equipment and can be removed from and re-inserted into the container 110. Insert tray 170 is adapted to stack on top of spittoon 180 when it is provided with its lid 182. Insert tray 170 has a recess 172 into which elongate handle 184 of spittoon 180 can fit when insert tray 170 is stacked on top of spittoon 180. The tray 170 also has a handle 174 to assist the user with holding and moving the insert tray 170.

FIG. 13a of the accompanying drawings shows another container 210 of a similar design to container 110. Container 210 has a handle (not shown) of the same “upside-down L” shape design as handle 130. In FIG. 13a the container 210 has insert tray 270 and spittoon 280, provided with its spittoon lid 282, positioned inside its hollow body, within the second compartment. The insert tray 270 is stacked on top of spittoon 280 and so only insert tray 270 is visible.

However, FIG. 13b of the accompanying drawings shows the insert tray 270 and spittoon 280, with spittoon lid 282, in this stacked arrangement. It can be seen that spittoon 280 is generally cuboidal and its handle 284 extends from a position half way along one of the shorter sidewalls of spittoon 280. In the stacked arrangement shown, the handle 284 fits into a recess 272 in insert tray 270.

The insert tray 270, spittoon 280, and spittoon lid 282 fit inside the second compartment of container 210 such that the insert tray 270, spittoon 280, and spittoon lid 282 are secure (prevented from moving) within the compartment of the hollow body of container 210 during transportation. This reduces the likelihood of any contents, e.g. potentially infectious bodily fluids, of spittoon 280 spilling or sloshing out whilst the container 210 is being moved.

1. A method of holding combat sport equipment, wherein the method comprises the steps of:
providing a container, the container comprising:
a hollow body defined by four sidewalls that extend from a closed base to an open mouth; and
a handle provided on one of the sidewalls of the hollow body, the handle comprising a first elongate member and a second elongate member, wherein:
the first elongate member has an elongate axis that lies parallel to the plane of the closed base; and
the second elongate member has an elongate axis that lies perpendicular to the plane of the closed base; and
placing combat sport equipment in the container.

2. The method according to claim 1, wherein the method is a method of moving combat sport equipment and comprises the further step of:
moving the container having combat sport equipment therein, so as to move the combat sport equipment from a first location to a second location.

3. The method according to claim 2, wherein one or more steps of the method are carried out before, during or after a combat sport event or contest.

4. The method according to claim 3, wherein the container is moved from a first location outside a fighting area to a second location inside a fighting area, or wherein the container is moved from a first location inside a fighting area to a second location outside a fighting area.

5. The method according to claim 4, wherein the container is moved between or under ropes that mark the perimeter of the fighting area.

6. The method according to claim 2, wherein the movement comprises using the handle of the container to push the container or using the handle of the container to both lift the container and push the container into position.

7. The method according to claim 1, wherein the handle is in a fixed position relative to the hollow body.

8. The method according to claim 1, wherein the second elongate member of the handle is directly connected to the first elongate member.

9. The method according to claim 1, wherein the handle is rigid.

10. The method according to claim 1, wherein the handle is located substantially centrally with respect to the width of the sidewall.

11. The method according to claim 1, wherein the handle is located substantially centrally or in the upper half with respect to the height of the sidewall.

12. The method according to claim 1, wherein the handle is T-shaped, C-shaped or L-shaped.

13. The method according to claim 1, wherein the container is used in combination with at least one removable receptacle, and wherein the container is adapted to receive the removable receptacle.

14. The method according to claim 13, wherein the or each removable receptacle is selected from the group consisting of insert trays and spittoons and combinations thereof.

15. The method according to claim 14, wherein the removable receptacle is a spittoon comprising a hollow body with an open mouth, and having an elongate handle that extends away from the open mouth.

16. The method according to claim 15, wherein handle has an engagement region, which may be a hook-like or loop-like region, located at a distal end of the handle, away from the hollow body of the spittoon.

17. The method according to claim 15, wherein the spittoon is provided with a lid.

18. The method according to claim 14, wherein the container is used in combination with a plurality of spittoons, wherein said plurality of spittoons are adapted to stack with one another.

19. The method according to claim 14, wherein the container is used in combination with an insert tray and a spittoon.

20. The method according to claim 19, wherein the spittoon has a lid and the insert tray is adapted to stack on top of the spittoon when the spittoon is closed by its lid.
